(19) United States
(12) Patent Application Publication
(10) Pub. No.: US 2017/0165137 A1
(43) Pub. Date: Jun. 15, 2017

(54) Secure Transfer Ramp for Car to wheelchair

(71) Applicant: Timothy Michael Schrader, Boynton Beach, FL (US)

(72) Inventor: Timothy Michael Schrader, Boynton Beach, FL (US)

(21) Appl. No.: 15/275,348

(22) Filed: Sep. 24, 2016

Related U.S. Application Data
(60) Provisional application No. 62/274,507, filed on Jan. 4, 2016.

(51) Int. Cl. A61G 3/06; A61G 7/10

(52) U.S. Cl. CPC A61G 3/061; A61G 7/103

(57) ABSTRACT

Transfer ramp for Car to wheelchair. This new design safely helps transfer someone from or to the car or wheelchair is disclosed. My design is self-supporting between the seat, car frame and floorboard ledge. It is only supported from the car side. The person can actually sit on the edge of the board before sliding over to the wheelchair. It is more of a platform then a transfer board. It is more fixed then a standard transfer board. This designs minimizes the 12″ gap that we had when using the standard wood transfer board.

### CROSS REFERENCE TO RELATED APPLICATION

A provisional application was filed for this non provisional application with a receipt date of 4 Jan. 2016 from the “Electronic acknowledgement receipt and the Confirmation letter no 8260 (from the USPTO)”. The provisional application No. 62/274,507. The attorney docket number is 515006698.

### STATEMENT REGARDING FEDERALLY SPONSORED RESEARCH AND DEVELOPMENT

Not Applicable

### NAMES OF THE PARTIES TO A JOINT RESEARCH AGREEMENT

Not Applicable

### REFERENCE TO A SEQUENCE LISTING

Not Applicable

### STATEMENT REGARDING PRIOR DISCLOSURES BY THE INVENTOR OR A JOINT INVENTOR

Not applicable.

### BACKGROUND OF THE INVENTION

### Problem Solved

When using a standard transfer board to go from the car to wheelchair (or vice versa) it is possible to slip off the board and the patient ends up on the floor board of the car. This has happened to my wife and is very humiliating for her. Many people buy expensive wheel chair vans to avoid this.

The standard transfer board is supported by the wheelchair seat and the car seat. A 13″ gap exist with the 2013 Volt and other cars where it is possible to slip off these standard boards. Other people in the rehabs have complained about feeling insecure on the standard transfer boards.

### BRIEF SUMMARY OF THE INVENTION

My design is self-supporting between the seat, car frame and floorboard ledge. The gap is minimized to within about 1-2″ It is only supported from the car side and does not depend on the wheelchair to support the one ends as a standard transfer board does. The person can actually sit on the edge of the board before sliding over to the wheelchair. It is more of a ramp/platform then a transfer board. It is more fixed and less likely to move then a standard transfer board.

### DESCRIPTION OF DRAWING

See the drawing titled “Safer Transfer Ramp details”. The ramp is shown in the car in FIGS. 1 and 2. The views of FIG. 3 show the 3 orthographic views of the board by itself.

FIG. 1 shows a side view cross section of how the removable ramp is supported securely in the car.

FIG. 2 shows the plan view. All contact points/surfaces to the car are labeled S1 thru S5.

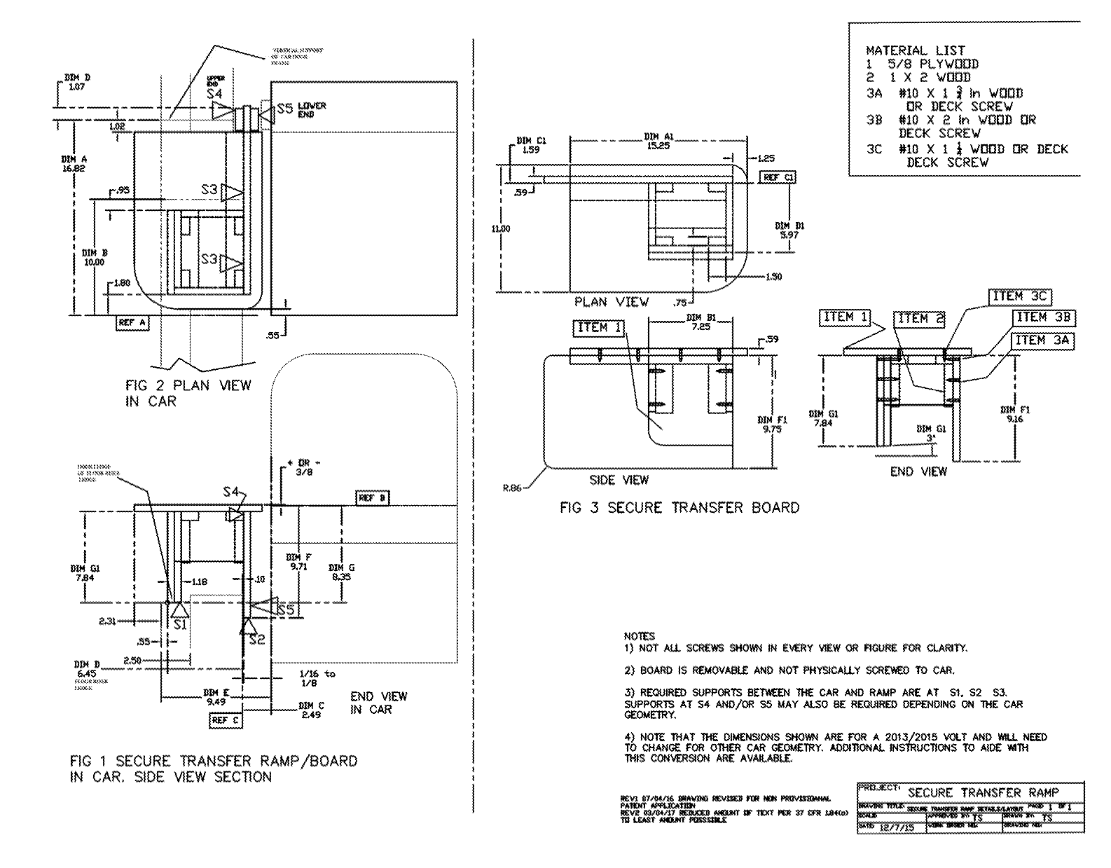

For additional safety an optional safety line (not shown) can be attached to the lower seat framing with a shackle.

### DETAILED DESCRIPTION OF THE INVENTION

My design is self-supporting between the seat, car frame and floorboard ledge by the 5 support points shown in the drawing. It is only supported from the car side. The person can actually sit on the edge of the board before sliding over to the wheelchair. It is more of a platform then a transfer board. It is more fixed then a standard transfer board.

Relationship Between the Components:

The ⅝ Plywood (item 1) is cut into 6 parts or shapes. There is a top shelf that the person slides over. Three other shapes make up the main support leg, one inner and one outer leg. The inner leg works against the car frame and lower floorboard riser ledge for support. As shown by supports S1 thru S5 in the drawing. Other parts/shapes act as gussets to strengthen the resistance of the board to warping or twisting under load. The 1×2 wood doublers help screw the parts/shapes/panel together. Without these doublers the plywood could split when screwing the panels together.

The Version of the Invention Discussed here Includes:
1. ⅝ in plywood cut into six shapes or parts
2. 1×2 wood
3. Wood screw #10×¾ in
4. Wood Screw #10×2 in
5. Wood screw #10×1¼ in

How the Invention Works:

The component assembly works by providing support point between the board and the car. The panel dimensions are dependent on the car dimensions to accomplish this support without any permanent attachments or screws between the car and board. The board is removable for ease of use. The outboard leg handles the most load. The inner leg is supported by the inner door ledge preventing it from moving outboard from the car. The inner leg also supports against the vertical door frame for additional rigidity.

How to Make the Invention:

Components can be readily bought at any major hardware store. Assembly is simple as shown in the available drawing. Additional drawing pages are available which detail the assembly steps. A chart is also provided in the additional assembly instructions showing how to take measurements in the car the ramp will be made for. The chart also shows how to calculate the required board dimensions from the Car dimensions.

All items shown are required. Additional supports can be added, if required. These are shown as supports S4 and S5 in the available drawing.

The dimensions of the board can be adjusted to fit any number of cars. The prototype board shown in the drawing is for a 2013 Volt.

How to Use the Invention:

Once the board dimensions have been adjusted to fit the particular car model it becomes a snug fit. The operator simply places the board between the seat, floor board riser ledge and door frame. It is then ready to be used

1) The claimed invention differs from what currently exists. As I have scanned googlepatents.com, the USPTO search engines and other sites, and could not find the same removable device.

2) Dependent on claim #1) This device is fully supported by the car and, safer than the simple boards that are more commonly sold that need to be supported by the car seat and wheelchair seat.

3) The new design (minimizes the possibility of slipping off). This invention is an improvement on what currently exists. The standard Boards are limited in how wide then can be. These standard boards can slip on the car or wheelchair seats.
